(19) United States
(12) Patent Application Publication
(10) Pub. No.: US 2016/0099570 A1
(43) Pub. Date: Apr. 7, 2016

(54) Compact Omnidirectional Modular Power Harvesting System

(71) Applicant: Stephens Sin-Tsun The', Newark, DE (US)

(72) Inventor: Stephens Sin-Tsun The', Newark, DE (US)

(21) Appl. No.: 14/507,726

(22) Filed: Oct. 6, 2014

(51) Int. Cl. H02J 3/38; H02J 7/34; H02J 7/35; H02J 9/00; H02J 7/00

(52) U.S. Cl. CPC H02J 3/382; H02J 3/383; H02J 3/386; H02J 9/00; H02J 7/0068; H02J 7/35; H02J 7/34

(57) ABSTRACT

The present invention relates to a compact omnidirectional energy harvesting system consisting of a semi-spherical (geodesic dome) shaped photovoltaic collector- and vertical-axis wind turbine, equipped with a power management system to convert, optimize and store the resulting solar, wind and auxiliary energy into electrical energy. The present invention has auxiliary energy capture ports to harvest ambient energies such as thermoelectric, piezoelectric, electromechanical, hydroelectric, rectifying antenna, electrostatic and electrochemical through plug-in modules. The resulting combined electrical energy, from all potential sources, is stored in rechargeable batteries or capacitors for eventual consumption to power lights, sensors, beacons, transmitters, cameras, wireless communications, or to provide a power supply in remote locations.

### BACKGROUND OF THE INVENTION

### Reference Cited

| | | | |
|---|---|---|---|
| 8,312,733B2 | November 2012 | Tsarev et al | 62/238.3 |
| 6,980,228 B1 | December 2005 | Harper | 348/81 |
| 8,539,724 | September 2013 | Bullivant et al | 52/173.3 |
| US2013/0234645 A1 | September 2013 | Goei et al | 320/101 |
| 7,268,517 B2 | September 2007 | Rahmel et al | 320/101 |

Electronic devices operated in remote areas posed special challenges for energy management, particularly where access to the electrical grid is not available. Navigational lighting and environmental monitoring devices require the use of lights, sensors, beacons, transmitters and wireless communications devices. Because of their remote locations, these devices require power from independent energy sources. Fossil fuel generators are undesirable in many situations where fuel leaks could adversely impact the surrounding environment or where refueling would be difficult or impracticable. Replaceable batteries are a disadvantage where access to the battery is difficult. For example, neither would be an ideal solution to power a navigational buoy isolated in the middle of waters or an environmental monitoring station in the middle of a remote desert. Ideally, remote locations require an independent, self-contained power system that continually and reliably harvests its ambient energies.

As with most energy harvesting systems, the primary source would be solar and wind energy, which would then be converted into electricity, as seen in U.S. Pat. No. 8,312,733 B2 for renewable energy.

Advancements in integrated circuits and micro-fabrication have resulted in ever smaller electronic devices to perform complex functions, while consuming less power. If the Moore's Law continues to hold, it is expect to see the doubling of circuit performance every 2 years. As a result, electronic devices used in sensing, monitoring, tracking and communicating would consume less electricity and would be increasingly more powerful. Similarly in LED lighting systems, the Haitz's Law predicts that light generated per watt to increase by a factor of 20 every decade. This translates to LED luminous efficacy of reaching 200 lumens per watt by 2020, significantly higher than compared to incandescent and fluorescence lights (approximately 10 and 60 lumens per watt respectively). Since these advancements would continue to significantly reduce the power load requirements for lighting and electronics, energy harvesting units are feasible options for supplying the necessary power.

What we are proposing is a new design to the existing concept of energy harvesting that will result in a portable, compact, self-contained, robust, easy to install and maintain, clean energy system that will capture not only solar and wind energy, but can be upgraded to capture other sources of ambient energy.

The compact omnidirectional modular power harvesting system utilizes a vertical-axis wind turbine below a geodesic dome of photovoltaic cells, thereby allowing for the omnidirectional collection of solar and wind energies. In addition, the system has external ports that provide the option to add auxiliary modules that capture other sources of ambient energy by taking advantage of vibrations, thermal gradient or stray electromagnetic radiations using rectifying antennas as presented in U.S. Pat. No. 7,268,517, and utilizing technologies such as micro-electromechanical systems (MEMS) to integrate various sources of energies. It can also take power from conventional sources as backups, like the power grid when they are available. A power conditioning unit is installed to accommodate the fluctuating and intermittent voltages and currents associated with ambient energies. The salient feature of our power management system is the ‘ring-of-power” where it would take of the electricity from various modules, and to regulate and condition them into common voltage and current to be charged into a battery bank.

The resulting combination of energy harvesting modules converts the ambient energy into power which is stored in re-chargeable batteries that eventually feed the associated lights, sensors, beacons, transmitters, cameras or wireless communications devices.

Typical solar energy harvesting systems are large, flat and require continual re-alignment of the photovoltaic cells to capture sunlight due to daily and seasonal variations in solar insolation. A stationary photovoltaic module in turns, would inherently sacrifice optimal solar capture thru its fixed-installed panels. Furthermore, most wind turbines require structures that are tall enough to capture the wind and strong enough to resist the high torque. These design requirements result in high capital and installation costs.

Other sources of ambient energy devices commercially available are of smaller type, typically used as toys or stands alone units, and are not easily integrated into larger energy system.

In contrast, the proposed compact omnidirectional modular power harvesting system would be relatively small and portable, yet sufficiently powerful to power remote electronic devices. The unit will be available in multiple sizes, with the basic unit sized approximately one to two feet diameter by two to four feet high, capable of producing between 50 to 500 watt hours per day from solar and wind sources alone. With the use of the auxiliary modules to capture other sources of ambient energy capture devices, the capacity could become significantly greater.

The intent of this invention is to capture the optimum ambient energy per unit volume or maximum energy captured with minimum footprint, as well as capitalizing and simplifying integration of other ambient energy sources available in the location. The power management unit ring-of-power would regulate energy inputs from various sources, manage re-chargeable battery charging and usage cycles, and allow seamless modularized attachment of other ambient energy sources such as piezoelectric, thermoelectric, electromechanical, hydroelectric, rectifying antenna, electrostatic and electrochemical uniquely abundant to the specific location of interest.

In situations where additional loads are planned, multiple units can be installed, in an array, to increase the power output.

The re-chargeable battery banks can be designed as needed to provide power for extended usage during such time where solar radiation, wind or other sources of energy are limited or interrupted.

The wind turbine of the compact omnidirectional modular power harvesting unit will operate at low sporadic wind speeds above one meter per second and the solar component will capture sunlight fluctuating above 100 watt/m². The wind turbine would have an electronic clutch to regulate safe and optimum rotational speed. Internal electronic tracking will maximize the solar energy capture depending on the trajectory of solar radiation.

Since no field calibration is required, installation is very straightforward, requiring just the connecting of compact omnidirectional modular power harvesting unit to a previously available surface (eg: pole, buoy, roof) in any unobstructed area. The compact omnidirectional modular power harvesting unit is completely self-sufficient does not require any additional electrical or mechanical connections, other than to the remote device to be powered. However, the unit can be connected into existing power system to provide backup. The system requires no maintenance lubrication and preventative maintenance is limited to replacing the re-chargeable battery on a 2-3 year interval.

The unit will be made of metal alloy or high impact polymer, strong enough to withstand dirt, debris and most airborne objects, as well as extreme heat and cold conditions outdoor.

### BRIEF SUMMARY OF THE INVENTION

This invention is a compact omnidirectional modular power harvesting system.

Principally it is a compact clean energy unit consists of a photovoltaic thermoelectric geodesic dome and a vertical axis direct drive wind turbine, equipped with power management controller to optimize the energy storage of a rechargeable battery bank and to maximize the energy capture of auxiliary modularized ambient energy sources.

This system is ideally suited to solve the power problem for electronic devices in remote areas, for examples in navigational lighting and environmental monitoring which typically are located in remote locations or where traditional power grid is not readily accessible. Typical fossil fuel generators are undesirable in situations where leaks could adversely impact the surrounding environment, and replaceable batteries are a disadvantage where access to battery is difficult.

Unlike typical solar and wind generators which require either realignment of the photovoltaic cells to capture sunlight, or structure that are tall enough to capture wind energy and resist high torque, the proposed invention is compact, self-tracking, does not require alignment, easy to install and strong enough to withstand dirt, debris and most airborne objects. This invention also addresses the challenges of integrating energy from other sources unique to the specific location, for instance capturing vibrational energy from piezoelectric or hydroelectric energy from underwater currents where those energies are locally abundant.

This invention is a novel design of a compact, omnidirectional, robust, self-contained, self-charging, low maintenance, clean energy system that capture not only solar and wind energy, but also modularized to be upgraded to capture other sources of ambient energy. The geodesic dome photovoltaic design is superior to typical flat panel because it will allow maximum daily and seasonal solar capture due to electronic internal tracking. By making the photovoltaic cells in the shapes of trapezoids, hexagons and pentagons, not only it simplifies manufacturing, but also maximizes the surface coverage area. The vertical-axis Savonius wind turbine with permanent magnet generator is superior in sporadic turbulent wind encountered in the outdoors, as well as able to keep itself clean from debris. The energy management controller system, ring-of-power, which allow simplified modularized attachment of auxiliary energy sources such as piezoelectric, thermoelectric, hydroelectric turbine in order to maximize the ambient energy extraction makes this unit even more versatile and powerful. The compact geometry of solar and wind, and the particular modular energy combination in order to maximize energy capture per unit volume is unique for this invention. By making an enclosed system to withstand extreme weather, with robust battery charging system and requiring virtually no maintenance, makes this invention ideal for remote outdoor installations, as well as serving as a clean green energy backup where traditional sources of energy are limited.

### BRIEF DESCRIPTION OF THE SEVERAL VIEWS OF THE DRAWING

FIG. 1 shows how the overall assembly of present invention, consist of photovoltaic cells configured in a dome or geodesic shape (1), a thermoelectric dome (2), a direct drive wind generator (3), a Savonius type wind turbine (4), a battery pack (5), a power management controller (6) and a base plate with external ports to be connected to other ambient energy modules (7).

FIG. 2 shows the detail of the photovoltaic plate and the configuration of the cells. It has a semispherical dome shape and built from trapezoidal cells. The bottom layer is made of eight identically shaped large trapezoids (1a), and eight identical smaller trapezoids (1b).

FIG. 3 shows an alternative geodesic shape dome with photovoltaic cells in the shape of pentagons (1c) and hexagons (1d).

FIG. 4 shows a thermoelectric dome which can help to capture additional energy when the photovoltaic is hot. This dome is constructed of large (2a) and small (2b) trapezoidal thermoelectric plates.

FIG. 5 shows the vertical axis wind turbine generator housing assembly (3a) direct drive permanent magnet generator (3b)

FIG. 6 shows a Savonius type wind turbine with three vertical blades (4a)

FIG. 7 shows a twisted Savonius vertical axis wind with full rotational wind turbine blades (4b)

FIG. 8 shows the battery bank (5a) and power management and control system (6a) installed under the plate in turbine housing assembly.

FIG. 9 shows the base plate of energy management for power harvest modules. The external ports (7a) and (7b) allow additional modular attachments. Below the plate (7c) can be placed additional custom controller circuits.
FIG. 10 shows a representation how additional modules can be attached to the overall assembly through the base plate through external ports. Modules (8), (9) and (10) are representations of such ambient harvesting modules.

FIG. 11 shows a schematic diagram on how the external modules are connected through booster converter, power management, microcontroller and energy storage units.

### DETAILED DESCRIPTION OF THE INVENTION

This invention is a compact omnidirectional modular power harvesting system.

This system is ideally suited to solve the problem associated with powering electronic devices in remote areas, for examples in navigational lighting, such as buoys, and environmental monitoring which typically are in locations not easily accessible, or in locations or where a traditional power grid is not readily accessible.

Navigational lighting and environmental monitoring require the use of various lights, sensors, beacons, transmitters and wireless communications devices, typically on the order of several watts to tens of watts (decawatts or daW).

The daW is the sweet spot for a practical energy range to power most navigational lighting (1 to 50 watts), small satellite communication radar (up to 100 watts), as well as mobile computers (20 to 80 watts). If more power is required, this invention can be installed in an array with a recommended separation distance of at least four diameters apart, so as to maximize wind flow.

Particular examples of where this invention would be used are as follows: for powering a navigational buoy isolated in the middle of a large body of water; a power source aboard ocean going yachts or sailboats; or an environmental monitoring station in the middle of a remote desert. It is particularly challenging to provide continuous reliable energy to these types of remote sites.

In the case where fossil fuel generators are employed, they pose a particular undesirable challenge such as exhaust and fuel leaks that could adversely impact the surrounding environment. In addition, a constant logistical effort is required to keep maintenance and fuel inventory constantly available.

If batteries are used, the routine replacement of batteries would be disadvantageous especially where access to the battery or unit is difficult to access.

Ideally, remote locations require an independent and self-contained power system that continually and reliably harvests its ambient energies.

Principally this invention is a compact clean energy unit which consists of a photovoltaic thermoelectric dome and a vertical axis direct drive wind turbine, equipped with a unique power management controller to optimize the energy storage of a rechargeable battery bank and to maximize the energy capture of auxiliary modularized ambient energy sources.

Typical fossil fuel generators are undesirable in situations where leaks could adversely impact the surrounding environment, and replaceable batteries are a disadvantage where access to battery is difficult

Unlike typical solar and wind generators which require either realignment of the photovoltaic cells to capture sunlight, or structure that are tall enough to capture wind energy and resist high torque, the proposed invention is compact, self-tracking, does not require alignment, easy to install and strong enough to withstand dirt, debris and most airborne objects.

This invention also addresses the challenges of integrating energy from other sources unique to the specific location, for instance capturing vibrational energy from piezoelectric or hydroelectric energy from underwater currents where those energies are locally abundant.

Our invention focus on the compactness of the design with maximum energy capture per unit volume or with minimum footprint, as well as ease of use and installation with minimum infrastructure requirement, and installation as easy as securing this system on any firm surface, poles or existing structural framework.

This invention is a novel design of a compact, omnidirectional, robust, self-contained, self-charging, low maintenance, clean energy system that captures not only solar and wind energy, but is also modularized to be upgraded to capture other sources of ambient energy. The geodesic dome photovoltaic design is superior to typical flat panel solar designs because it will allow maximum daily and seasonal solar capture due to electronic internal tracking. This design with photovoltaic cells in the unique array of trapezoid, hexagon and pentagon shapes, simplifies manufacturing, but also maximizes the surface coverage area. The unique combination of including a vertical-axis Savonius wind turbine with permanent magnet generator is superior in sporadic turbulent wind encountered in the outdoors, as well as the ability to keep itself clean from debris. The energy management controller system, ring-of-power, which allows simplified modularized attachment of auxiliary energy sources such as piezoelectric, thermoelectric, hydroelectric turbine in order to maximize the ambient energy extraction makes this unit even more unique, versatile and powerful. The compact geometry of solar and wind, and the particular modular energy combination in order to maximize energy capture per unit volume is unique to this particular invention. By making an enclosed system to withstand extreme weather, with robust battery charging system and requiring virtually no maintenance, makes this invention ideal for remote outdoor installations, as well as serving as a clean green energy backup where traditional sources of energy are limited.

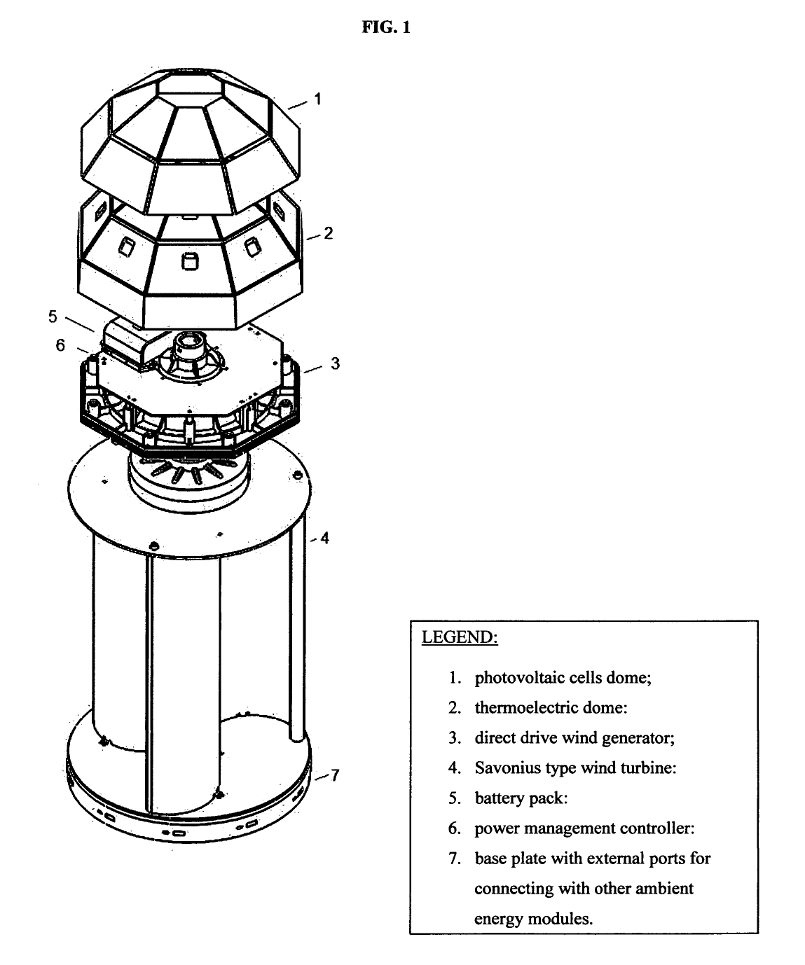

FIG. 1 shows how the overall assembly of the present invention which consists of photovoltaic cells configured in a dome shape (1); a thermoelectric dome (2); a direct drive wind generator assembly (3); a Savonius type wind turbine (4); a battery pack (5); a power management controller (6); and a base plate with external ports to be connected to other ambient energy modules (7).

This compact omnidirectional modular power harvesting system is a unique invention. We will address the major features one by one, as well as other benefits.

COMPACT: This invention is a compact system because all the power management capabilities fit in this geometric shape of photovoltaic dome and vertical cylinder of the wind turbine. As a compact unit with a built in photovoltaic, thermoelectric and wind turbine capabilities, this assembly is complete. It will capture solar, wind and heat energies and convert them to electricity, store the energy within the rechargeable battery and discharge the energy to the device connected to this unit via an electrical connectors or sockets. This geometry with geodesic on top of cylindrical is the optimum energy capturing per unit volume with the smallest installation footprint.

OMNIDIRECTIONAL: This invention is omnidirectional because it will capture any source of energy from any direction. With the geodesic dome shape, the photovoltaic cells can capture solar energy from various angles from daily or seasonal variations, in latitude and longitude, thus, it is omnidirectional. The internal tracking system will optimize each cell and to produce the maximum power to be captured as each of the cells will receive solar radiation at various angles. Likewise, the vertical axis wind turbine will capture any incoming wind energy at any radial angle. Because of its vertical shape, unlike the horizontal-axis turbine which needs to be aligned to wind direction, this turbine requires no alignment and is thus omnidirectional. The Savonius type wind turbine is chosen because it works well in sporadic winds.

MODULAR: A special feature for this invention is its modular aspect. The power management system, ring-of-power, is designed to take additional energy sources and integrate them with the existing energy architecture. For example, if the unit is placed in a location that has flowing water, such as in the ocean or near a river, additional modularized power generation, such as a turbine can be attached to the port and thus regulated as a single system, in conjunction with the existing solar, thermo and wind energy. In a location where vibrational energy is available, for example in a place such as roads or boardwalks, a piezoelectric module can be installed as additional or auxiliary energy. Similarly other modules can be added from other sources such as secondary photovoltaic and wind turbine, or sources from piezoelectric, thermoelectric, electromechanical, hydroelectric, rectifying antenna, electrostatic and electrochemical. In simple, the modularized unit is a “plug-and-play” versatile invention.

POWER HARVESTING: As the name implied, this invention is designed to be a flexible power harvester. It is therefore a green source of energy since it will take the energy from the surrounding environment and convert it into useable electrical energy. Typical power harvesting devices are used to power smaller electronic devices, in the order of micro to milliwatts. Our device is designed to be operated at the tens of watts (decawatts or daW) because we believe this is a “sweet spot” for most electronic navigational and environmental monitoring devices. It is sufficiently powerful to power onboard computer for most remote applications. As previously indicated, other power harvesting modules can be integrated via connecting ports.

In addition to the above features, this system is also designed to be self-cleaning and require low maintenance. Unlike a typical flat shape photovoltaic module, the dome shape photovoltaic does not allow accumulation of dirt or snow on the surface. The particular design of the vertical axis Savonius type wind turbine does not allow debris to get caught in the blades.

The system is designed to be robust with the entire unit hermetically sealed to prevent water from entering the system. The material of construction such as metal alloy or impact resistance polymer composite will allow the unit to withstand flying debris as well as being placed outdoors in extreme heat and cold conditions.

Because of the specific geometry and internal control, the unit does not require calibration. Thus, it significantly reduces the complexities of installation.

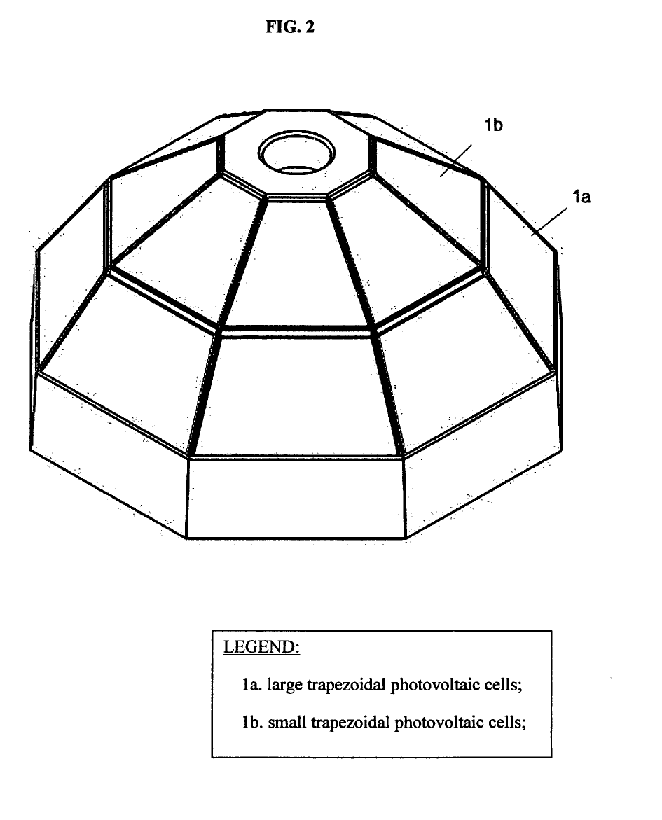

FIG. 2 shows the details of the photovoltaic plate and the configuration of the cells. It has a semispherical shape built from trapezoidal cells. The bottom layer is made of large trapezoids (1a), smaller trapezoids (1b). The resulting semispherical solar cells are omnidirectional, which means it can capture solar energy from any direction. Typical solar panel installation requires fixed axis to be aligned to the direction of the sun, or require a mechanical solar tracking system to move the solar panels. This simple passive design eliminates the requirement of a motor to tilt the panel such as done with flat plate to track the sun, therefore reduce maintenance.

These trapezoidal shape cells is made from a single crystal or polycrystalline cells, cut using laser cutting to fit in the geometry while maintaining a strict standard of voltage and current requirements. Once the current and voltage are established, the cut photovoltaic cells are arranged either in series or parallel in the geometry allocated, wired accordingly, and encased in polymer resin or in weather resistance glass. The particular size and geometry are arranged to give maximum coverage on the geodesic shape as to maximize energy capture at various solar angles.

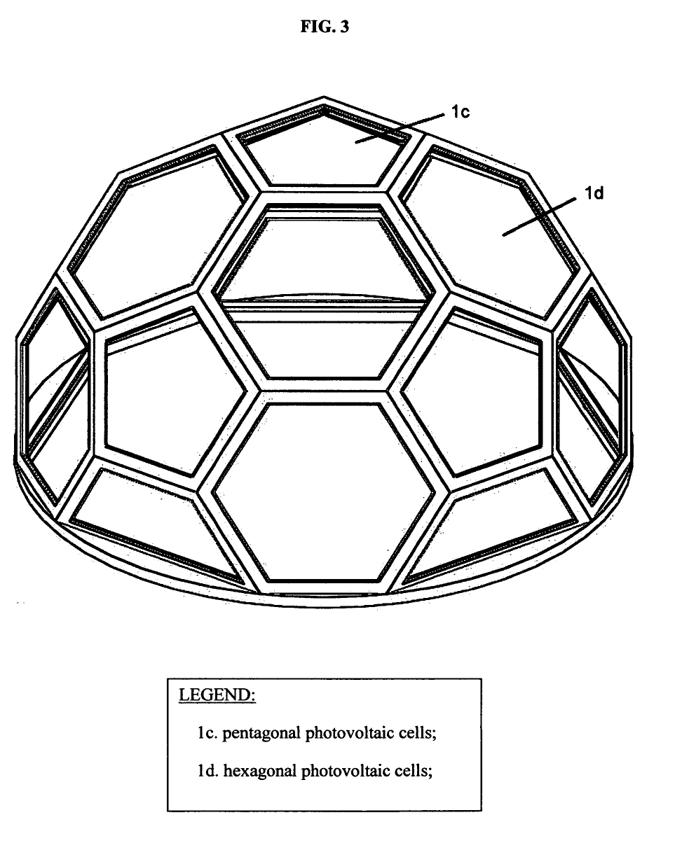

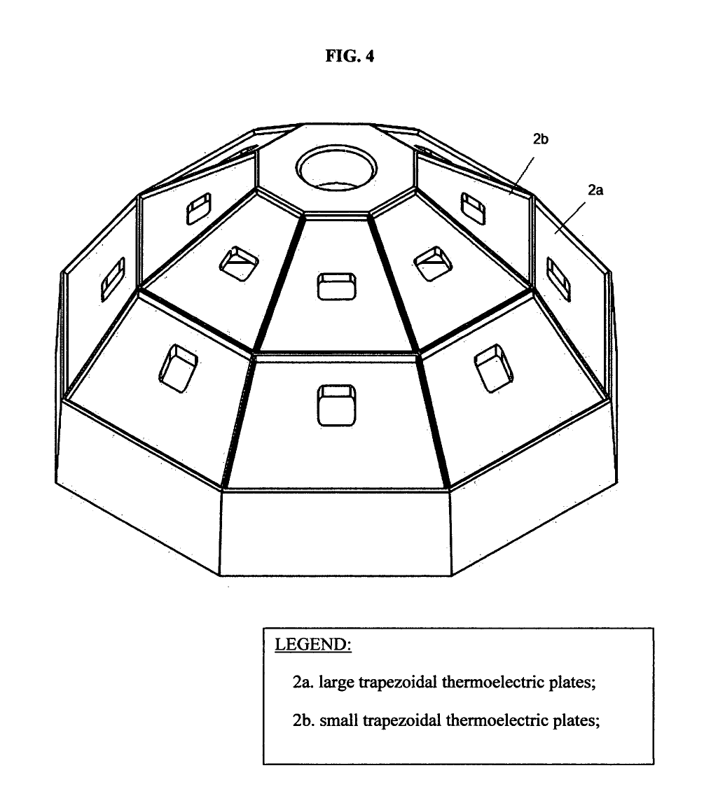

FIG. 3 An alternative design for this invention as a geodesic dome with pentagonal (1c) and hexagonal (1d) photovoltaic cells. Similar to the trapezoidal design, the dome is internally tracked to optimize the solar power capture at various angles. Likewise, the dome can also be built from identical triangle cells to form a rounded geodesic dome. As another alternative shape, the dome could be slightly more conical in shape.

There are many types of solar cells. For this invention, single crystal, polycrystalline, or triple junction cells are used to maximize the solar energy capture.

These pentagonal and hexagonal shape cells are made from a single crystal or polycrystalline cells, cut using laser cutting to fit in the geometry while maintaining a strict standard of voltage and current requirements. A triangular geometry can also be used to simplify manufacturing. Once the current and voltage are established, the cut photovoltaic cells are arranged either in series or parallel in the geometry allocated, wired accordingly, and encased in polymer resin or in weather resistance glass. The particular size and geometry are arranged to give maximum coverage on the geodesic shape so as to maximize energy capture at various solar angles.

FIG. 4 shows a thermoelectric dome which can help to capture additional energy when the photovoltaic is hot. This dome is build of large (2a) and small (2b) trapezoidal thermoelectric plates. Photovoltaic cells work more efficiently at lower temperatures. The efficiency decreases by about 0.5% for every degree Celsius increase. In a hot day, for example where the cell temperature is 25° C. higher than ambient, the power could be reduced by as much as 12%. During the summer, when the sunlight is at maximum and the photovoltaic gets hotter, the top of the thermoelectric dome will be hotter than the bottom thus, producing additional electricity. In winter time, the function can be reversed as a heater by sacrificing energy to melt the ice in order to keep the photovoltaic surface free from snow and ice.

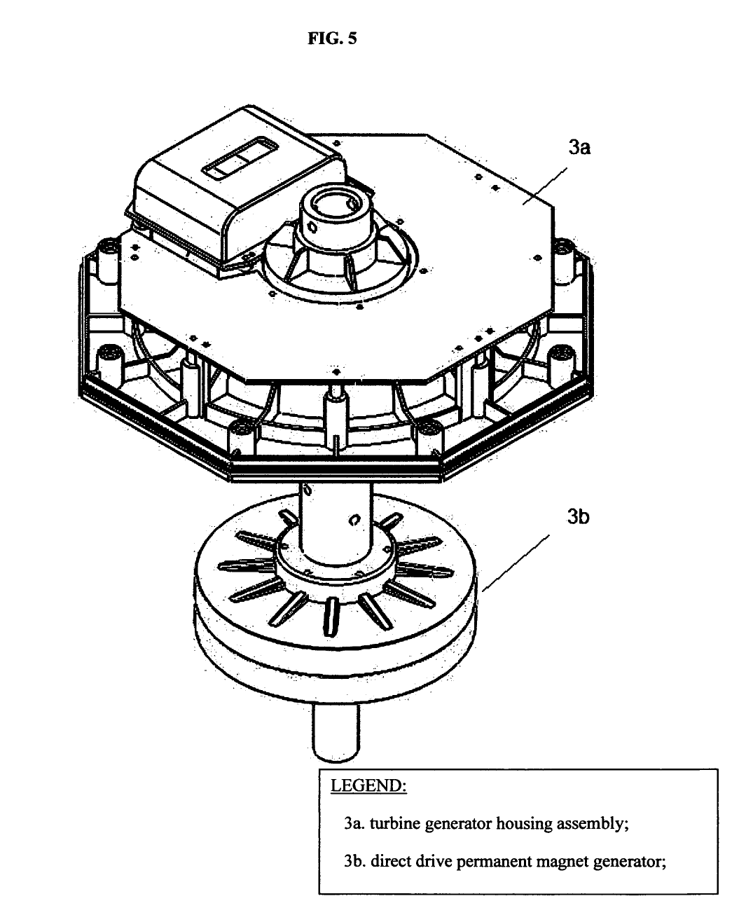

FIG. 5 shows the vertical axis wind turbine direct drive permanent magnet generator assembly (3a) and the generator (3b). The direct drive generator is more efficient than the corresponding gear system which runs at higher rotational speed. Direct drive design reduces the complexity of gear box and is easier to maintain. Direct drive can operate at lower torque and speed. A vertical axis is preferred to a horizontal axis because of the ability to capture intermittent turbulent wind. The direct axis, with permanent magnet, allows the blades to turn at low cut in speed.

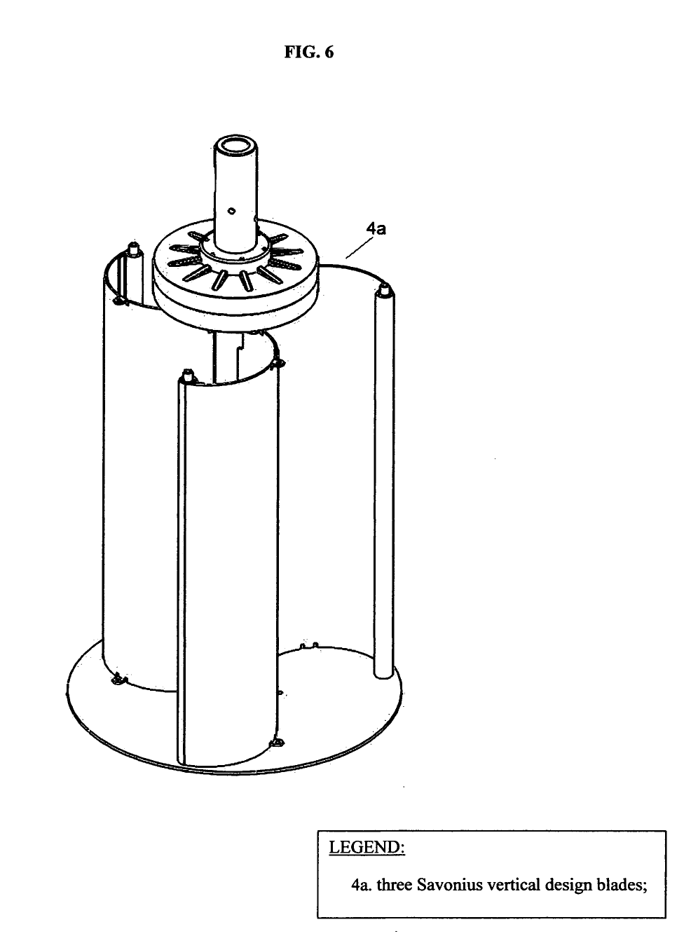

FIG. 6 shows three vertical blades (4a) of Savonius design. The drag type design is preferred in this invention because it is more robust and less likely to get clogged by flying debris, if installed closer to the ground, particularly along coastal areas. An alternative design is the twisted Savonius, which requires dual blades, but is more difficult to construct. The cut-in speed of this design is 2 meters per second. The preferred operating speed is 6 to 10 meters per second. This technology is efficient, quiet, and dependable.

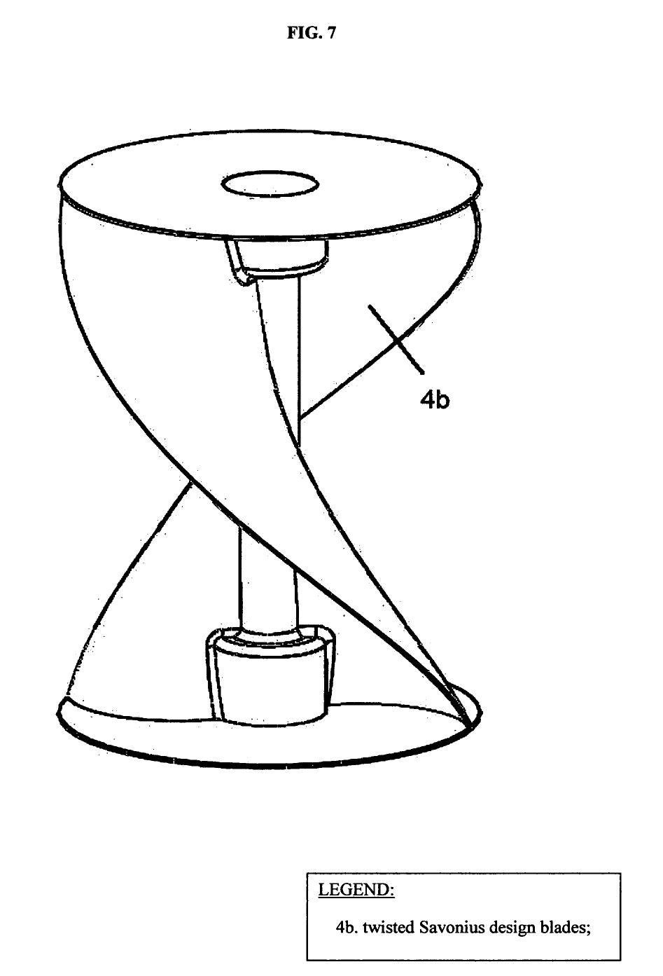

FIG. 7 shows a twisted Savonius wind turbine with one full rotation. The twisted Savonius design is ideal for areas where the wind is intermittent and sporadic.

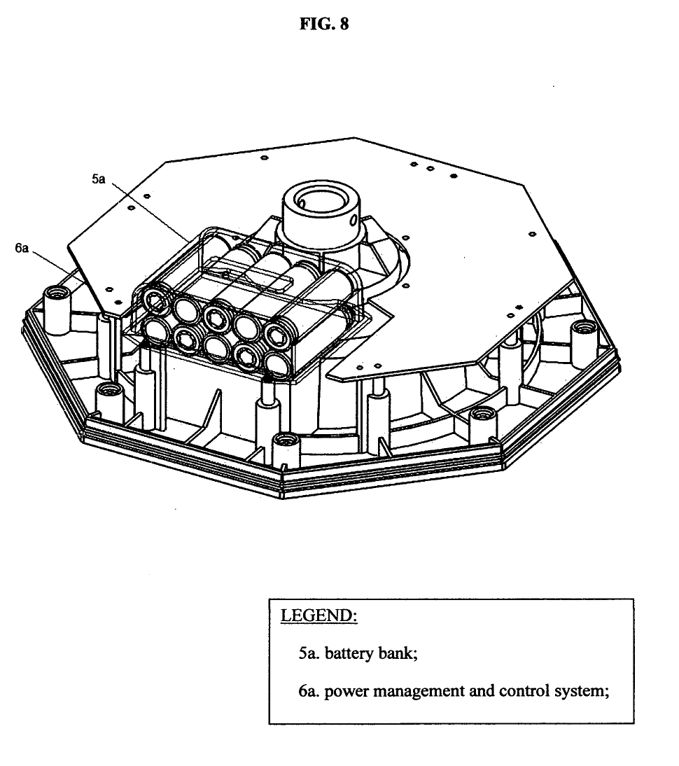

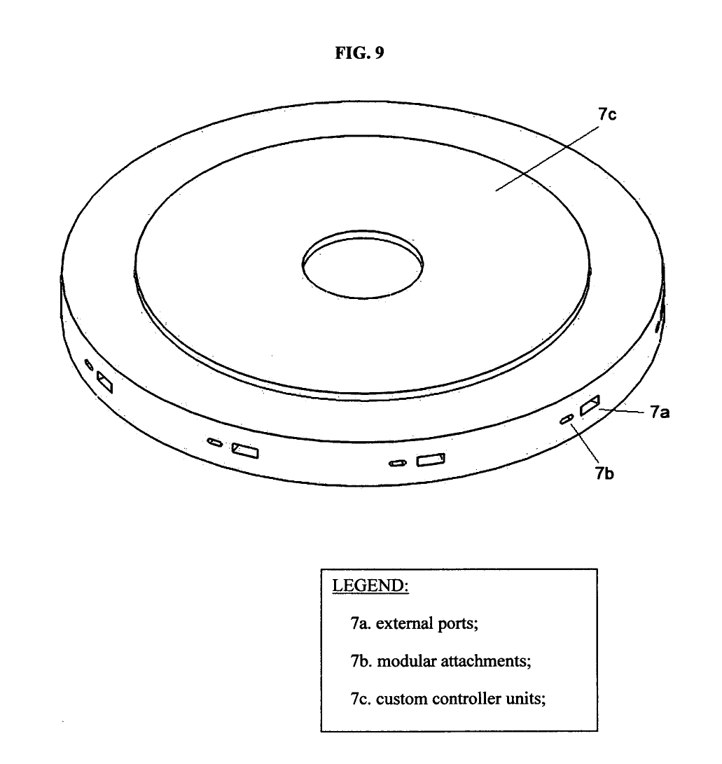

FIG. 8 shows the battery bank (5a) and power management and control system (6a) installed under the plate. The battery is a rechargeable lithium battery which is reliable and has lifetime of 2 to 3 years. The combined power obtained from the photovoltaic and wind turbine could reach greater than 10 watts for a unit with a diameter of one foot and height of two feet, thus producing up to 50 Wh per day on 5 hour per day operations in a 40 degree latitude. Depending on the geographical location, the solar radiation varies. For larger units with a diameter of 2 feet or greater and a height of four feet or greater, the combined solar and wind energy can reach 500 Wh per day with solar and wind, and even greater with additional integrated modules.

FIG. 9 shows the base plate of energy management for power harvest modules. In addition to the principal source of energy from solar and wind, the energy can also be obtained from other sources. The external ports (7a) and (7b) allow such additional modular attachments. Below the plate (7c) additional custom controller circuits can be placed.

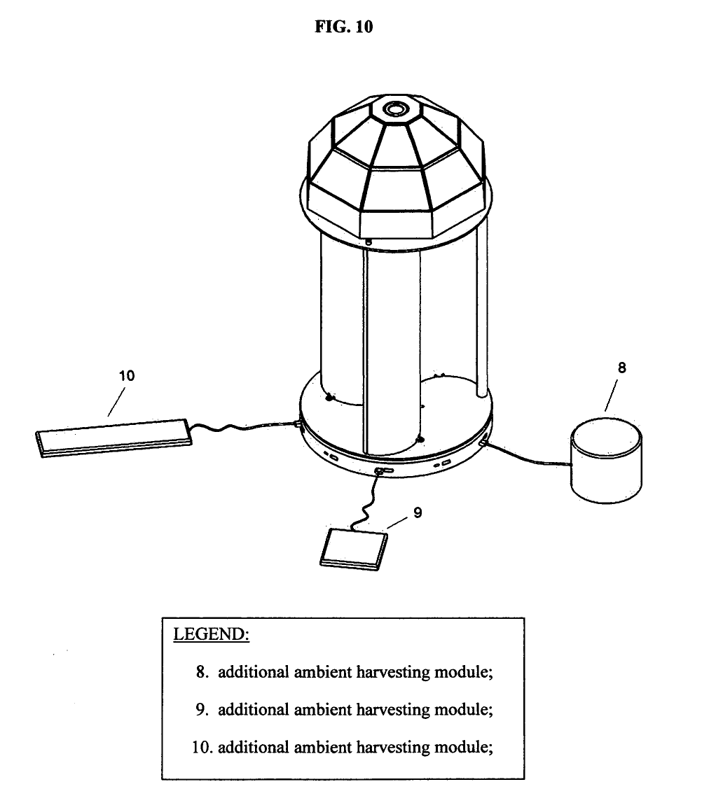

FIG. 10 shows a representation of how additional modules can be attached to the overall assembly through the base plate through external ports. Modules (8), (9) and (10) are representations of such ambient harvesting modules.

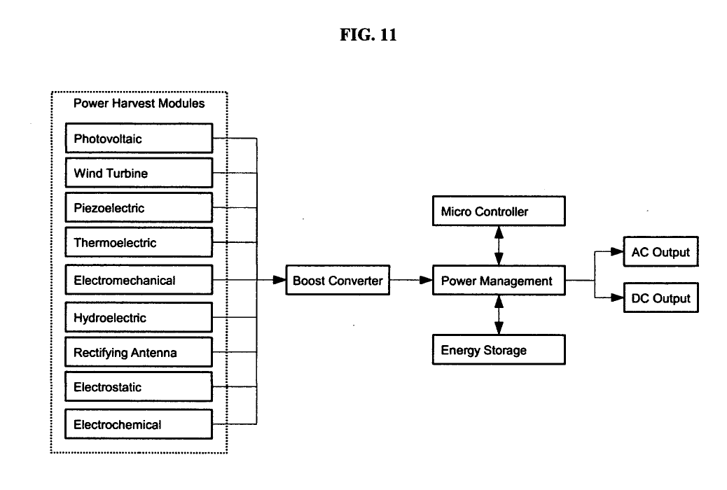

FIG. 11 shows a schematic diagram on how the modules are connected through a ring-of-power booster converter, power management, micro controller and energy storage units.

Various modules will provide alternative sources of energy to be converted into reusable energy to power various electronic devices. The charging schemes for example rectifier energy is described in U.S. Pat. No. 7,268,517. Depending on the module, the output can be fed to trickle charger circuitry and stored in energy storage devices.

Presented below is background information on thermoelectric, piezoelectric, electromechanical, hydroelectric, rectifying antenna, electrostatic and electrochemical. They are all possibilities of ambient energy to be harvested with this invention. They are not specific, but complementary to explain why the present invention both flexible and unique.

For the thermoelectric module, the energy comes from having a temperature gradient between two dissimilar conductors to produce voltage. The heat flow produces diffusion of charged carriers between the hot and cold regions creating a voltage difference. The heat absorbed or produced is proportional to the current. This thermoelectric effect which produces electricity from temperature gradient is called the Seebeck effect. The reverse of producing heat or cold from current through dissimilar conductors is called the Peltier effect. Modern thermoelectric materials are made of P− and N− doped bismuth-telluride semiconductors between two ceramic plates. If the electric current or voltage is produced from temperature changes or fluctuations at very high temperatures, it is called pyroelectric effect, ideal for converting waste heat to electricity. There are thermal sources everywhere that are not tapped.

For the piezoelectric module, the energy comes from mechanical strain which is converted into electric current or voltage. Piezoelectric harvesting can be done from environmental vibrations and movements. A practical application of ambient piezoelectricity is imbedding a piezoelectric device on the ground to harness environmental shock and impact energy, or vibration of structures.

For the electromechanical module, the conversion from mechanical energy to electrical energy can be conducted using devices such as MEMS which is well known in micro circuitry. The device translates acceleration and movement into electrical energy. Electromechanical devices in larger scale can harvest the movement of pistons or moving arms. A practical application of electromechanical device would be to harvest underwater ocean current or the up-and-down movement of waves or swell on the ocean surface.

For the hydroelectric module, the conversion water movement into electrical energy though turbines is well known in the art. This module requires a constant steady flow of water in order to capture its energy into electricity. A practical application of hydroelectric device would be to harvest a moving stream of water such as in a river.

For the rectifying antenna, the energy conversion of background electromagnetic spectrum is well known in the art. Advancement in thin film asymmetric tunneling diode allows harvesting of high frequency waves into electricity. A practical application of rectifying antenna device would be to harness stray or background radio frequency and electromagnetic radiations.

For the electrostatic module, the energy obtained from the changing capacitance of vibration-dependent capacitor is well known in the art. This module converts the change in polarization of electrically charged dielectric materials. A practical application of electrostatic device would be to harvest naturally occurring electrostatic charges induced by any action of friction or vibration.

For the electrochemical module, the conversion of electrodes redox-mediated electron transfer into electrical energy is well known in the art. There are examples such as thermo-electrochemical cells which harness the electricity from the temperature dependent in electrochemical cells. Fuel cells which convert hydrogen or other chemicals into electrical energy through catalytic membranes are also well known in the art. Fuel cells can work as both energy generating and as rechargeable battery. A practical application of electrochemical module will be to harness the environmental variation of chemical concentrations, such as ions, or to use it as battery backup for applications such as fuel cells.

The novel features of this invention have been described in detail. It is apparent to those skilled in the art, upon examination of this disclosure, to recognize that modifications are possible while maintaining the key teachings and unique advantages of this invention.

What is claimed is:

1. A compact omnidirectional modular power harvesting unit consists of:
A photovoltaic solar collector geodesic dome made of individual trapezoid cells configured in a semispherical configuration with the bottom layer which consists of large identical trapezoids, middle layer with of smaller identical trapezoids, with open top octagonal plate for device installation;
A smaller dome underneath the photovoltaic dome, which consists of similar but smaller trapezoid plates, made of thermoelectric material;
A vertical axis wind turbine with diameter equal to the base of photovoltaic dome and height of one and half of diameter, located directly underneath the thermoelectric dome, and equipped with three vertical blades spaced out 120 degree from each other. These blades are curved inward with a central axis shaft, a top and bottom circular plates, and a direct drive permanent magnet generator which consists of rotor and stator;
At least one rechargeable battery pack mounted on the top the stator under the thermoelectric dome;
A power management system and boost controller, mounted under the battery pack, to capture the energy from said photovoltaic dome, thermoelectric dome and vertical axis wind turbine, and to recharge and discharge the power from the battery; and a
Mean of transferring electricity from the solar, wind, thermoelectric, controller and battery.

2. A bottom disc support module which consists of external ports for electrical input and output to be connected to separate auxiliary energy harvesting modules, and has sufficient space to mount custom made control circuit inside the ports designed for each module, and means for electrical connectors to a power management system and a booster controller mentioned in claim 1;

3. The unit of claim 1, wherein the dome is geodesic semispherical made of pentagon, hexagon and half-hexagon photovoltaic cells arranged in configuration as to maximize the solar capture;

4. The unit of claim 3, wherein the dome is made of photovoltaic and outer focusing lens optical dome, made of high impact clear plastics such as polycarbonate, ceramics such as tempered glass or other clear impact resistance optical materials;

5. The unit of claim 1, where the vertical axis wind turbine is made with single helical blade, dual helical blades or triple helical blades twisted Savonius type designs;

6. An array system where multiples of unit of claim 1 are installed in an array pattern with distance of ideally 4 diameter width from each other and means of electrical transmission to connect individual units, thus producing larger power generation; and

7. Auxiliary external modules designed to connect with claim 2 specific for interface with the surrounding environment, such as water turbine, solar umbrella, piezoelectric, thermoelectric, electromechanical, hydroelectric, rectifying antenna, electrostatic and electrochemical energy generators.
